(19) United States
(12) Patent Application Publication
(10) Pub. No.: US 2026/0109195 A1
(43) Pub. Date: Apr. 23, 2026

(54) AIR CONDITIONER FOR VEHICLE

(71) Applicant: Hanon Systems, Daejeon (KR)

(72) Inventor: Hwan Kyu CHO, Daejeon (KR)

(73) Assignee: Hanon Systems, Daejeon (KR)

(21) Appl. No.: 19/112,050

(22) PCT Filed: Nov. 6, 2023
(86) PCT No.: PCT/KR2023/017621

§ 371 Date: Mar. 14, 2025

(30) Foreign Application Priority Data
Nov. 18, 2022 (KR) 10-2022-0155653
Nov. 3, 2023 (KR) 10-2023-0151006

(51) Int. Cl. B60H 1/00

(52) U.S. Cl. CPC B60H 1/00899

(57) ABSTRACT

A vehicular air conditioner according to the present invention includes: a refrigerant circulation line including a compressor, a condenser, a plurality of evaporators, and a plurality of expansion valves configured to depressurize and expand a refrigerant introduced into each of the evaporators, the evaporators including a main evaporator configured to basically operate in a vehicle interior cooling mode, and at least one sub evaporator configured to operate as needed; and a refrigerant flow control part configured to, under a vehicle interior cooling mode condition, block or permit introduction of the refrigerant to the sub-evaporator, or bypass the refrigerant before being introduced to the sub-evaporator to an inlet of the compressor while allowing the refrigerant to flow along a preset path.

### TECHNICAL FIELD

The present invention relates to a vehicular air conditioner, and more particularly, a vehicular air conditioner capable of, when a rear seat passenger wants mild wind under a vehicle interior cooling mode condition, blocking a refrigerant flow to a sub-evaporator side, blowing air to a rear seat side only by the blowing power of a blower fan, preventing the reduction in an overall refrigerant flow volume due to the blocking of the refrigerant flow to the sub-evaporator side and the resultant excessive increase in a refrigerant pressure inside the air conditioner, constantly maintaining the refrigerant pressure inside the air conditioner in a stable state regardless of whether the refrigerant flow to the sub-evaporator side is blocked, and improving the cooling performance for the vehicle interior.

### BACKGROUND ART

As shown in FIG. 1, a vehicle is equipped with an air conditioner 10 that cools and heats an air conditioning region.

The air conditioner 10 includes a refrigerant circulation line 12. The refrigerant circulation line 12 includes a compressor 14, a condenser 15, a plurality of evaporators 16 installed in parallel with each other, and expansion valves 17 and 18 installed on the upstream side of the respective evaporators 16.

The evaporators 16 include a main evaporator 16a used for cooling the front seat region of the vehicle interior, and a sub-evaporator 16b used for cooling the rear seat region of the vehicle interior.

The main evaporator 16a is installed on the front seat side of the vehicle interior and is basically operated in the cooling mode of the vehicle interior, and the sub-evaporator 16b is installed on the rear seat side of the vehicle interior and is operated as needed in the cooling mode of the vehicle interior.

The expansion valves 17 and 18 are installed on the portions of the refrigerant circulation line 12 at the inlets of the respective evaporator 16a and 16b to depressurize and expand the refrigerant introduced into the respective evaporator 16a and 16b.

Meanwhile, a two-way on-off valve 19 is installed on the portion of the refrigerant circulation line 12 between the condenser 15 and the expansion valve 18 for the sub-evaporator.

The on-off valve 19 is configured to block or open the refrigerant circulation line 12 depending on the air conditioning mode, thereby restricting or permitting the refrigerant flow from the condenser 15 side to the sub-evaporator 16b side.

In particular, when executing a rear seat side cooling mode, the on-off valve 19 is turned on to open the refrigerant circulation line 12, thereby permitting a refrigerant flow from the condenser 15 side to the sub-evaporator 16b side.

Therefore, the refrigerant depressurization and expansion operation in the expansion valve 18 for the sub-evaporator is permitted so that the operation of the sub-evaporator 16b starts according to the depressurization and expansion operation of the refrigerant, thereby cooling the rear seat region of the vehicle interior.

When the rear seat side cooling mode is released, the on-off valve 19 is turned off to block the refrigerant circulation line 12, thereby restricting the refrigerant flow from the condenser 15 side to the sub-evaporator 16b side.

Therefore, the refrigerant depressurization and expansion operation in the expansion valve 18 for the sub-evaporator can be restricted, and the operation of the sub-evaporator 16b can be stopped due to the restriction of the refrigerant depressurization and expansion operation, which makes it possible to restrict the rear seat region cooling.

However, in such a conventional air conditioner, when a rear side passenger wants mild wind in a vehicle interior cooling mode, for example, when a rear seat blowing mode is selected, the on-off valve 19 is turned off to block the refrigerant flow to the sub-evaporator 16b side, and air is blown to the rear seat side only by the wind power of a blower fan 20.

In this case, since the refrigerant to be circulated to the sub-evaporator 16b side is circulated only to the main evaporator 16a side, there is a disadvantage in that the refrigerant circulation amount on the main evaporator 16a side excessively increases.

In particular, the amount of refrigerant in the refrigerant circulation line 12 is determined based on the amount of refrigerant flowing to the sub-evaporator 16b side. As mentioned above, if the refrigerant flow to the sub-evaporator 16b side is blocked, the sub-evaporator 16b through which the refrigerant can flow and the surrounding refrigerant circulation line 12 are also blocked.

Accordingly, there is a disadvantage in that the total refrigerant flow volume through which the refrigerant can flow is reduced.

Due to this disadvantage, there is a problem in that the internal pressure of the refrigerant circulation line 12 excessively increases as the refrigerant is excessively concentrated only to the main evaporator 16a side.

Because of this problem, there is a disadvantage in that the control stability of the air conditioner is reduced, and as a result, the cooling performance in the vehicle interior and the driving performance of the vehicle are reduced.

In particular, the rotation speed (rpm) of the compressor 14 and the opening degree of the electromagnetic expansion valve (EXV) 17 on the main evaporator 16a side are variably controlled according to the refrigerant pressure in the refrigerant circulation line 12. However, as described above, there is a disadvantage that malfunction occurs when the refrigerant pressure in the refrigerant circulation line 12 increases excessively. Due to this disadvantage, there is a problem that the vehicle interior cooling performance is reduced.

Meanwhile, in view of this, if a rear seat passenger wants mild wind in the vehicle interior cooling mode, the on-off valve 19 is turned on to maintain the refrigerant flow to the sub-evaporator 16b side, and then a separate electric heater (not shown), for example, a PTC heater can be used to gently heat the air blown toward the rear seat.

However, even in this case, the separate electric heater has to be used.

Therefore, there is a disadvantage in that unnecessary energy consumption occurs.

Due to this disadvantage, there is a problem in that the fuel efficiency and electricity efficiency of the vehicle are significantly reduced.

### DETAILED DESCRIPTION OF THE INVENTION

### Technical Task

The present invention has been made to solve the above-mentioned problems of the prior art, and it is an object of the present invention to provide a vehicular air conditioner capable of, when a rear seat passenger wants mild wind under a vehicle interior cooling mode condition, blocking a refrigerant flow to a sub-evaporator side, blowing air to a rear seat side only by the blowing power of a blower fan, and preventing the reduction in an overall refrigerant flow volume due to the blocking of the refrigerant flow to the sub-evaporator side and the resultant excessive increase in a refrigerant pressure inside the air conditioner.

Another object of the present invention is to provide a vehicular air conditioner configured to block the refrigerant flow to the sub-evaporator side without worrying about a decrease in the overall refrigerant flow volume and an excessive increase in the refrigerant pressure inside the air conditioner, and to blow mild air to the rear seat side only with the wind power of a blower fan, thereby maintaining the refrigerant pressure inside the air conditioner at a stable state regardless of whether the refrigerant flow to the sub-evaporator side is blocked.

A further object of the present invention is to provide a vehicular air conditioner configured to maintain the refrigerant pressure inside the air conditioner at a stable state regardless of whether the refrigerant flow to the sub-evaporator side is blocked, thereby preventing the deterioration of air conditioner control stability due to excessive increase in the refrigerant pressure inside the air conditioner and the resultant reduction in the vehicle interior cooling performance.

A still further object of the present invention is to provide a vehicular air conditioner capable of blowing mild wind to a rear seat passenger without operating a separate electric heater when the rear seat passenger want the gentle wind under a vehicle interior cooling mode condition.

A yet still further object of the present invention is to provide a vehicular air conditioner configured to blow mild wind to a rear seat passenger without operating a separate electric heater, thereby preventing unnecessary energy consumption and consequently improving the fuel efficiency and electricity efficiency of a vehicle.

### Means to Solve the Task

In order to achieve these objects, the present invention provides a vehicular air conditioner, including: a refrigerant circulation line including a compressor, a condenser, a plurality of evaporators, and a plurality of expansion valves configured to depressurize and expand a refrigerant introduced into each of the evaporators, the evaporators including a main evaporator configured to basically operate in a vehicle interior cooling mode, and at least one sub evaporator configured to operate as needed; and a refrigerant flow control part configured to, under a vehicle interior cooling mode condition, block or permit introduction of the refrigerant to the sub-evaporator, or bypass the refrigerant before being introduced to the sub-evaporator to an inlet of the compressor while allowing the refrigerant to flow along a preset path.

The main evaporator may be used for front seat side cooling in a vehicle interior, the sub-evaporator may be used for rear seat side cooling in the vehicle interior, and the refrigerant flow control part may include a three-way flow control valve with integrated on/off function installed in the refrigerant circulation line between the condenser and the sub-evaporator to block or open a portion of the refrigerant circulation line between the condenser and the sub-evaporator or to bypass the refrigerant before being introduced to the sub-evaporator, a bypass line configured to bypass the refrigerant bypassed from the three-way flow control valve to the inlet of the compressor along a preset path, and a valve control part configured to control the three-way flow control valve according to an air conditioning mode state to block or permit refrigerant flow to the sub-evaporator or to bypass the refrigerant before being introduced to the sub-evaporator to the bypass line.

When the rear seat side cooling mode is turned off under the vehicle interior cooling mode condition, the valve control part may control the three-way flow control valve to block the refrigerant circulation line between the condenser and the sub-evaporator and block the refrigerant flow to the sub-evaporator.

When the rear seat side cooling mode is turned on under the vehicle interior cooling mode condition, the valve control part may control the three-way flow control valve to open the refrigerant circulation line between the condenser and the sub-evaporator and permit the refrigerant flow to the sub-evaporator.

When a rear seat passenger wants mild wind and selects a rear seat blowing mode under the vehicle interior cooling mode condition, the valve control part may control the three-way flow control valve to bring a portion of the refrigerant circulation line on the condenser side into communication with the bypass line to bypass the refrigerant before being introduced to the sub-evaporator to the bypass line.

The bypass line may be configured so that the total refrigerant flow volume inside the bypass line is the same as the total refrigerant flow volume from the three-way flow control valve to the sub-evaporator and the compressor, and when the rear seat passenger wants the mild wind and selects the rear seat blowing mode, the bypass line can accommodate the same amount of refrigerant as the refrigerant accommodation amount in a path from the three-way flow control valve to the sub-evaporator and the compressor.

The bypass line may further include a throttle valve configured to depressurize the bypassed refrigerant and introduce the bypassed refrigerant to the compressor.

When the front seat side cooling mode is turned off and the rear seat side cooling mode is turned on under the vehicle interior cooling mode condition, the refrigerant flow control part may control the three-way flow control valve to bypass the refrigerant on the condenser side introduced to the main evaporator to the bypass line.

When the front seat side cooling mode is turned off and the rear seat side cooling mode is turned on under the vehicle interior cooling mode condition, the valve control part may control the expansion valve for the main evaporator to block introduction of the refrigerant to the main evaporator side, and may control the three-way flow control valve to bring the refrigerant circulation line on the condenser side into communication with the refrigerant circulation line on the sub-evaporator side and bring the refrigerant circulation line on the condenser side into communication with the bypass line, thereby permitting the refrigerant flow to the sub-evaporator and bypassing the refrigerant introduced to the main evaporator to the bypass line.

### Effect Of The Invention

According to the vehicular air conditioner of the present invention, when the rear seat passenger wants mild wind under the vehicle interior cooling mode condition, the refrigerant introduced to the sub-evaporator side is bypassed to the bypass line side and then introduced to the compressor side.

Therefore, the bypass line can accommodate a certain amount of refrigerant that will flow to the sub-evaporator side. As a result, despite the refrigerant flow to the sub-evaporator side being blocked, it is possible to prevent the reduction in the overall refrigerant flow volume due to the refrigerant flow to the sub-evaporator side being blocked and the resulting excessive increase in the refrigerant pressure inside the air conditioner.

In addition, since the reduction in the overall refrigerant flow volume due to the refrigerant flow to the sub-evaporator side being blocked and the resulting excessive increase in the refrigerant pressure inside the air conditioner can be prevented despite the refrigerant flow to the sub-evaporator side being blocked, the refrigerant pressure inside the air conditioner can always be maintained in a stable state regardless of whether the refrigerant flow to the sub-evaporator side is blocked.

In addition, since the refrigerant pressure inside the air conditioner can always be maintained in a stable state regardless of whether the refrigerant flow to the sub-evaporator side is blocked, it is possible to prevent deterioration of the air conditioner control stability and the vehicle interior cooling performance due to the excessive increase in the refrigerant pressure inside the air conditioner.

In addition, since the refrigerant flow to the sub-evaporator side can be blocked without worrying about the decrease in the overall refrigerant flow volume and the excessive increase in the refrigerant pressure inside the air conditioner, and only the wind power of the blower fan can be used to blow mild air to the rear seat side, it is not necessary to operate an electric heater to blow mild air to the rear seat side as is the case in the related art.

In addition, since the mild air can be blown to the rear seat passenger without operating the electric heater, it is possible to prevent unnecessary energy consumption and consequently improve the fuel efficiency and electricity efficiency of the vehicle.

### BRIEF DESCRIPTION OF THE DRAWINGS

FIG. 1 is a view showing the configuration of a conventional vehicular air conditioner.

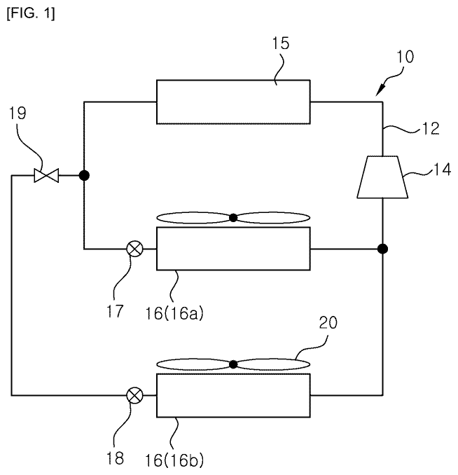

FIG. 2 is a view showing the configuration of a vehicular air conditioner according to the present invention.

FIG. 3 is an operation diagram of the vehicular air conditioner according to the present invention, showing a state in which the flow of refrigerant to a sub-evaporator is blocked when a rear seat cooling mode is released under a vehicle interior cooling mode condition.

FIG. 4 is an operation diagram of the vehicular air conditioner according to the present invention, showing a state in which the flow of refrigerant to the sub-evaporator is permitted when the rear seat cooling mode is released under the vehicle interior cooling mode condition.

FIG. 5 is an operation diagram of the vehicular air conditioner according to the present invention, showing a state in which the refrigerant before being introduced to the sub-evaporator is bypassed to the compressor side when a rear seat passenger selects a rear seat blowing mode under the vehicle interior cooling mode condition and wants mild wind.

FIG. 6 is an operation diagram of the vehicular air conditioner according to the present invention, showing a state in which the refrigerant introduced to the main evaporator is bypassed to the compressor side when a front seat side cooling mode is released and a rear seat side cooling mode is executed under the vehicle interior cooling mode condition.

FIG. 7 is a view showing a vehicular air conditioner according to another embodiment of the present invention.

### BEST MODE TO IMPLEMENT THE INVENTION

Hereinafter, preferred embodiments of a vehicular air conditioner according to the present invention will be described in detail with reference to the accompanying drawings. The same components as those of the above-described prior art will be designated by the same reference numerals.

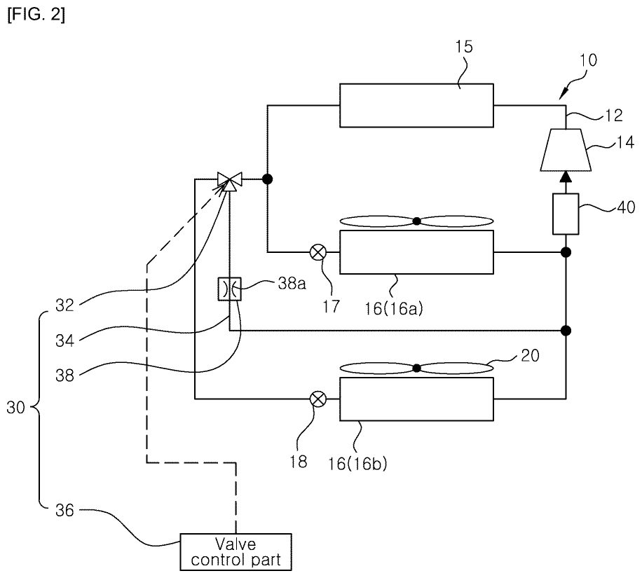

First, prior to describing the features of the vehicular air conditioner according to the present invention, the general aspect of the vehicular air conditioner will be briefly described with reference to FIG. 2.

The vehicular air conditioner includes a refrigerant circulation line 12.

The refrigerant circulation line 12 includes a compressor 14, a condenser 15, a plurality of evaporators 16 installed in parallel with each other, and expansion valves 17 and 18 installed on the upstream side of the respective evaporators 16.

The evaporators 16 include a main evaporator 16a used for cooling the front seat region of the vehicle interior, and a sub-evaporator 16b used for cooling the rear seat region of the vehicle interior.

The main evaporator 16a is basically operated in a vehicle interior cooling mode and is installed on the front seat side of the vehicle interior.

The sub-evaporator 16b is operated as needed in the vehicle interior cooling mode and is installed on the rear seat side of the vehicle interior.

The expansion valves 17 and 18 are installed on the portions of the refrigerant circulation line 12 at the inlets of the respective evaporator 16a and 16b to depressurize and expand the refrigerant introduced into the respective evaporator 16a and 16b.

In this regard, the main evaporator 16a is basically operated in the vehicle interior cooling mode, but may be stopped when a passenger inside the vehicle turns off the front seat side cooling or when a passenger rides only on the rear seat side inside the vehicle in an autonomous vehicle.

Next, the features of the vehicular air conditioner according to the present invention will be described in detail with reference to FIGS. 2 to 7.

Referring first to FIG. 2, the air conditioner of the present invention includes a refrigerant flow control part 30 that blocks the introduction of refrigerant from the condenser 15 side to the sub-evaporator 16b side, or permits the introduction of refrigerant from the condenser 15 side to the sub-evaporator 16b side, or bypasses the refrigerant from the condenser 15 side to the inlet side of the compressor 14 along a preset path before being introduced to the sub-evaporator 16b side, depending on the air conditioning mode state in the vehicle interior cooling mode.

The refrigerant flow control part 30 includes an on/off integrated three-way flow control valve 32 installed in the portion of the refrigerant circulation line 12 between the condenser 15 and the expansion valve 18 for the sub-evaporator, a bypass line 34 for bypassing the refrigerant bypassed from the three-way flow control valve 32 to the inlet side of the compressor 14, and a valve control part 36 for controlling the three-way flow control valve 32 according to an air conditioning mode state.

The three-way flow control valve 32 is an integrated on/off valve having on/off valve functions, and is configured to block or permit the refrigerant flow from the condenser 15 to the sub-evaporator 16b side, or bypass the refrigerant on the condenser 15 side to the bypass line 34 side before being introduced to the sub-evaporator 16b side, depending on the air conditioning mode state.

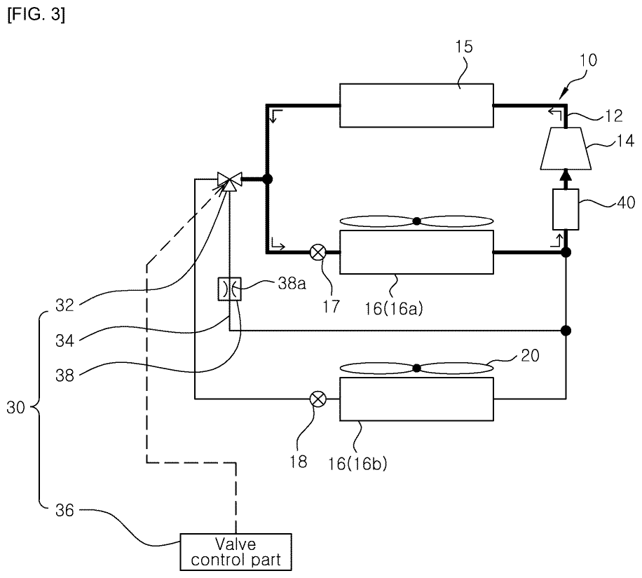

In particular, when the rear seat cooling is turned off, as shown in FIG. 3, the refrigerant circulation line 12 between the condenser 15 and the sub-evaporator 16b side is blocked, thereby blocking the refrigerant flow from the condenser 15 side to the sub-evaporator 16b side.

Therefore, the refrigerant depressurization and expansion operation in the expansion valve 18 for the sub-evaporator can be restricted, and the operation of the sub-evaporator 16b can be stopped according to the restriction of the refrigerant depressurization and expansion operation, thereby restricting the rear seat side cooling.

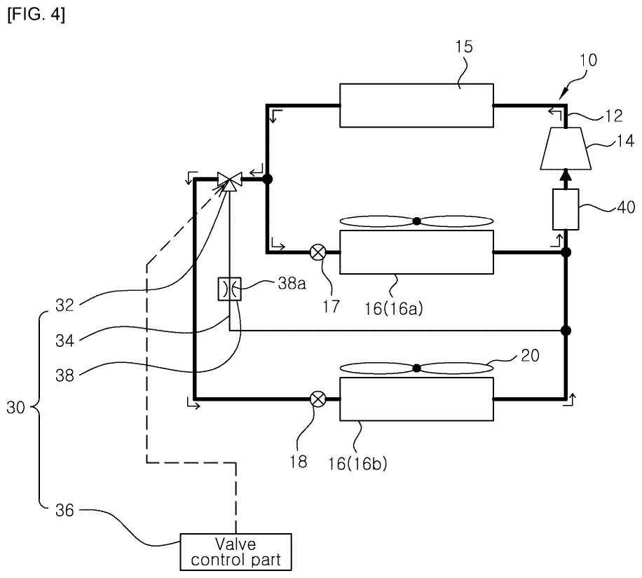

When the rear seat side cooling is turned on, as shown in FIG. 4, the refrigerant circulation line 12 between the condenser 15 and the sub-evaporator 16b is opened, thereby permitting the refrigerant to flow from the condenser 15 side to the sub-evaporator 16b side.

Therefore, the refrigerant depressurization and expansion operation in the expansion valve 18 for the sub-evaporator can be permitted, and the operation of the sub-evaporator 16b can be started according to the refrigerant depressurization and expansion operation, thereby cooling the rear seat region of the vehicle interior.

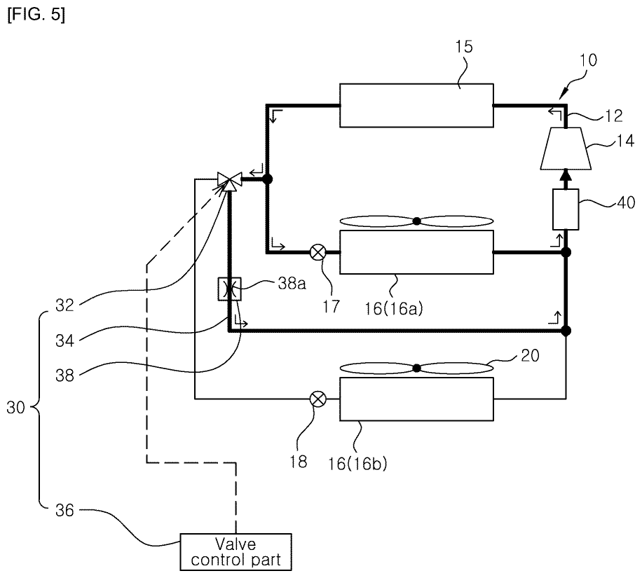

When a rear seat passenger selects a rear seat blowing mode and wants only mild wind, as shown in FIG. 5, the portion of the refrigerant circulation line 12 on the condenser 15 side and the bypass line 34 are brought into communication with each other.

Therefore, the condenser 15 side refrigerant before being introduced to the sub-evaporator 16b side is bypassed to the bypass line 34.

As a result, the introduction of the condenser 15 side refrigerant to the sub-evaporator 16b is blocked, while the circulation of the condenser 15 side refrigerant to the compressor 14 through the bypass line 34 is permitted.

The bypass line 34 introduces the condenser 15 side refrigerant bypassed by the three-way flow control valve 32 to the inlet of the compressor 14.

In particular, the bypass line 34 has a fixed path extending from the three-way flow control valve 32 and is connected to the inlet of the compressor 14.

The bypass line 34 introduces the bypassed condenser 15-side refrigerant to the inlet of the compressor 14 while flowing along the fixed path.

Therefore, when the rear seat passenger wants mild wind and selects the rear seat blowing mode, the bypass line 34 receives fixed amount of refrigerant instead of the refrigerant flowing to the sub-evaporator 16b side.

As a result, despite the refrigerant flow to the sub-evaporator 16b side being blocked, it is possible to prevent the overall refrigerant flow volume decrease due to the blocking of the refrigerant flow to the sub-evaporator 16b side and the excessive refrigerant pressure increase in the air conditioner.

As a result, regardless of whether the refrigerant flow to the sub-evaporator 16b is blocked, the refrigerant pressure inside the air conditioner can be maintained at a stable state.

Accordingly, it is possible to prevent the decrease in the control stability of the air conditioner due to the excessive increase in refrigerant pressure inside the air conditioner and the resulting decrease in the vehicle interior cooling performance.

Preferably, the total refrigerant flow volume inside the bypass line 34 may be set to be equal to the total refrigerant flow volume from the three-way flow control valve 32 to the sub-evaporator 16b and the compressor 14.

The reason for adopting this configuration is to ensure that the bypass line 34 can accommodate the same amount of refrigerant as the amount of refrigerant flowing to the sub-evaporator 16b side when the rear seat passenger wants only mild wind and selects the rear seat blowing mode.

Therefore, when the rear seat passenger wants only mild wind, the refrigerant flow to the sub-evaporator 16b side is blocked. Nevertheless, the total refrigerant flow volume reduction due to the blocking of the refrigerant flow to the sub-evaporator 16b side and the excessive refrigerant pressure increase in the air conditioner due to the blocking can be prevented as much as possible.

Meanwhile, a throttle valve 38 for reducing the refrigerant pressure is installed on the bypass line 34.

The throttle valve 38 has a throttle flow path 38a and reduces the pressure of the refrigerant on the condenser 15 side bypassed to the bypass line 34.

Therefore, the pressure of the refrigerant introduced to the inlet of the compressor 14 along the bypass line 34 is lowered.

Again, referring to FIG. 2, the valve control unit 36 controls the on/off integrated three-way flow control valve 32 according to the air conditioning mode state under the cooling mode condition inside the vehicle.

In particular, as shown in FIG. 3, when the rear seat cooling is turned OFF, the three-way flow control valve 32 is turned OFF.

Accordingly, the portion of the refrigerant circulation line 12 between the condenser 15 and the sub-evaporator 16b side is blocked, thereby blocking the refrigerant flow from the condenser 15 side to the sub-evaporator 16b side. By doing so, the operation of the sub-evaporator 16b is stopped to restrict the rear seat side cooling.

As shown in FIG. 4, when the rear seat side cooling is turned on, the three-way flow control valve 32 is turned on to open the portion of the refrigerant circulation line 12 between the condenser 15 and the sub-evaporator 16b.

Accordingly, the refrigerant flow from the condenser 15 side to the sub-evaporator 16b side is permitted. By doing so, the operation of the sub-evaporator 16b is permitted to start the rear seat side cooling.

As shown in FIG. 5, when the rear seat passenger wants mild wind and selects a rear seat blowing mode, the three-way flow control valve 32 is turned on to bring the condenser 15-side portion of the refrigerant circulation line 12 into communication with the bypass line 34.

Accordingly, the condenser 15-side refrigerant before being introduced to the sub-evaporator 16b side can be bypassed to the bypass line 34.

As a result, the refrigerant flow to the sub-evaporator 16b side is restricted, while the circulation of the condenser 15-side refrigerant through the bypass line 34 to the compressor 14 side is permitted.

Meanwhile, in the detailed description and drawings, it is described that only when the rear seat passenger selects the rear seat blowing mode under the vehicle interior cooling mode condition, the refrigerant flow control part 30 circulates the refrigerant on the condenser 15 side before being introduced into the sub-evaporator 16b to the compressor 14 side while bypassing it to the bypass line 34.

However, even when the rear seat side cooling is turned off, the three-way flow control valve 32 can be turned on to circulate the refrigerant on the condenser 15 side before being introduced into the sub-evaporator 16b to the compressor 14 side while bypassing it to the bypass line 34.

The reason for adopting this configuration is to ensure that the same amount of refrigerant as the amount of refrigerant flowing to the sub-evaporator 16b side can be accommodated in the bypass line 34 even when the rear seat side cooling is turned off.

Therefore, when the rear seat side cooling is turned off, even though the refrigerant flow to the sub-evaporator 16b side is blocked, the decrease in the total refrigerant flow volume due to the blocking of the refrigerant flow to the sub-evaporator 16b side and the resulting excessive refrigerant pressure increase inside the air conditioner can be prevented as much as possible.

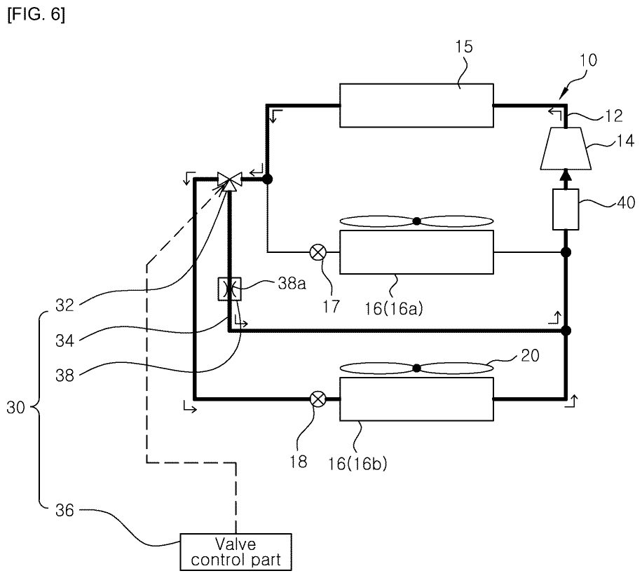

In addition, as shown in FIG. 6, the refrigerant flow control unit 30 can control the three-way flow control valve 32 to circulate the refrigerant on the condenser 15 side introduced to the main evaporator 16a to the compressor 14 side while bypassing it to the bypass line 34 even when the front seat side cooling is turned off and the rear seat side cooling is turned on under the vehicle interior cooling mode condition.

That is, when the front seat side cooling is turned off and the rear seat side cooling is turned on under the vehicle interior cooling mode condition, the three-way flow control valve 32 brings the portion of the refrigerant circulation line 12 on the condenser 15 side into communication with the portion of the refrigerant circulation line 12 on the sub-evaporator 16b side, and brings the portion of the refrigerant circulation line 12 on the condenser 15 side into communication with the bypass line 34.

Therefore, the refrigerant flow from the condenser 15 side to the sub-evaporator 16b side is permitted, and the refrigerant on the condenser 15 side upstream of the main evaporator 16a is bypassed to the bypass line 34.

Thus, when the front seat side cooling is turned off and the rear seat side cooling is turned on, the sub-evaporator 16b is operated to cool the rear seat side inside the vehicle, and the refrigerant on the condenser 15 side is allowed to circulate to the compressor 14 side through the bypass line 34.

As a result, when the front seat side cooling is turned off, the bypass line 34 can accommodate a certain amount of refrigerant instead of the refrigerant that would flow to the main evaporator 16a side.

Accordingly, even though the refrigerant flow to the main evaporator 16a side is blocked, it is possible to prevent the reduction in the overall refrigerant flow volume due to the blocking of the refrigerant flow to the main evaporator 16a side and the resulting excessive increase in the refrigerant pressure inside the air conditioner.

This allows the refrigerant pressure inside the air conditioner to be maintained in a stable state regardless of whether the refrigerant flow to the main evaporator 16a side is blocked.

When the front seat side cooling is turned off, the valve control part 36 turns off the electromagnetic expansion valve 17 on the upstream side of the main evaporator 16a, thereby blocking the introduction of the refrigerant to the main evaporator 16a side.

Referring again to FIG. 2, the air conditioner according to the present invention further includes a gas-liquid separator 40 installed in the portion of the refrigerant circulation line 12 between the bypass line 34 and the inlet of the compressor 14.

The gas-liquid separator 40 separates the refrigerant recovered to the compressor 14 side into a liquid and a gas, and introduces only the separated gas refrigerant into the compressor 14.

In particular, since the refrigerant on the bypass line 34 side is depressurized and expanded by the throttle valve 38 without separate evaporation, the ratio of the liquid phase is very high.

Therefore, if such liquid refrigerant flows into the compressor 14, there is a risk of damage to the compressor 14. Thus, it is necessary to separate the gas component of the refrigerant recovered from the bypass line 34 to the compressor 14 side.

Accordingly, the gas-liquid separator 40 separates the refrigerant recovered from the bypass line 34 to the compressor 14 side into a liquid and a gas, and introduces them into the compressor 14.

In this regard, the gas-liquid separator 40 is preferably installed in a portion of the refrigerant circulation line 12 between the bypass line 34 and the inlet of the compressor 14 on the common downstream side of the bypass line 34 and the main evaporator 16a and the sub-evaporator 16b.

In particular, the gas-liquid separator 40 is preferably installed in the portion where the refrigerants passing through the bypass line 34, the main evaporator 16a, and the sub-evaporator 16b merge.

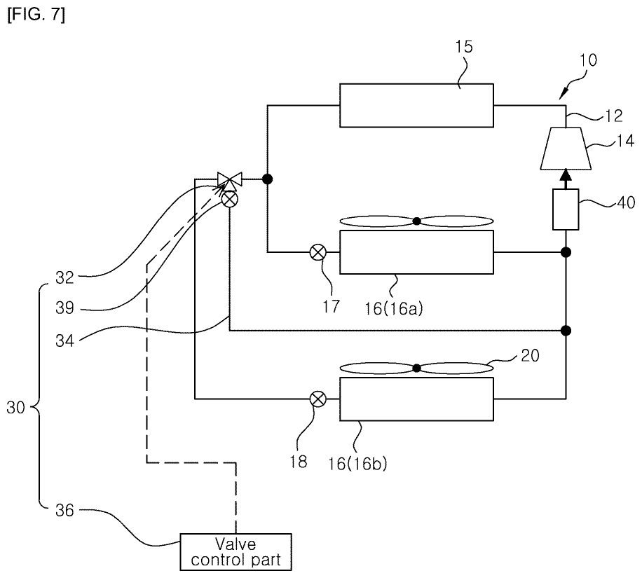

Next, a vehicular air conditioner according to another embodiment of the present invention will be described with reference to FIG. 7.

The vehicular air conditioner according to another embodiment of the present invention has substantially the same structure as the above-described vehicular air conditioner. However, the throttle valve 38 (see FIG. 2) installed on the bypass line 34 is not present, and instead, the three-way flow control valve 32 has an expansion valve function.

The three-way flow control valve 32 has a structure in which the expansion valve 39 is integrally installed in a portion corresponding to the bypass line 34. The three-way flow control valve 32 bypasses the refrigerant on the condenser 15 side to the bypass line 34, and depressurizes and expands the bypassed refrigerant.

Therefore, the pressure of the refrigerant recovered to the compressor 14 along the bypass line 34 is lowered.

According to the vehicular air conditioner of the present invention, when the rear seat passenger wants mild wind under the vehicle interior cooling mode condition, the refrigerant introduced to the sub-evaporator 16b side is bypassed to the bypass line 34 side and then introduced to the compressor 14 side.

Therefore, the bypass line 34 can accommodate a certain amount of refrigerant that will flow to the sub-evaporator 16b side. As a result, despite the refrigerant flow to the sub-evaporator side being blocked, it is possible to prevent the reduction in the overall refrigerant flow volume due to the refrigerant flow to the sub-evaporator 16b side being blocked and the resulting excessive increase in the refrigerant pressure inside the air conditioner.

In addition, since the reduction in the overall refrigerant flow volume due to the refrigerant flow to the sub-evaporator 16b side being blocked and the resulting excessive increase in the refrigerant pressure inside the air conditioner can be prevented despite the refrigerant flow to the sub-evaporator 16b side being blocked, the refrigerant pressure inside the air conditioner can always be maintained in a stable state regardless of whether the refrigerant flow to the sub-evaporator 16b side is blocked.

In addition, since the refrigerant pressure inside the air conditioner can always be maintained in a stable state regardless of whether the refrigerant flow to the sub-evaporator 16b side is blocked, it is possible to prevent deterioration of the air conditioner control stability and the vehicle interior cooling performance due to the excessive increase in the refrigerant pressure inside the air conditioner.

In addition, since the refrigerant flow to the sub-evaporator 16b side can be blocked without worrying about the decrease in the overall refrigerant flow volume and the excessive increase in the refrigerant pressure inside the air conditioner, and only the wind power of the blower fan 20 can be used to blow mild air to the rear seat side, it is not necessary to operate an electric heater to blow mild air to the rear seat side as is the case in the related art.

In addition, since the mild air can be blown to the rear seat passenger without operating the electric heater, it is possible to prevent unnecessary energy consumption and consequently improve the fuel efficiency and electricity efficiency of the vehicle.

While the preferred embodiments of the present invention have been described above by way of example, the scope of the present invention is not limited to such specific embodiments, and may be appropriately changed within the scope recited in the claims.

1. A vehicular air conditioner, comprising:
a refrigerant circulation line including a compressor, a condenser, a plurality of evaporators, and a plurality of expansion valves configured to depressurize and expand a refrigerant introduced into each of the evaporators, the evaporators including a main evaporator configured to basically operate in a vehicle interior cooling mode, and at least one sub evaporator configured to operate as needed; and
a refrigerant flow control part configured to, under a vehicle interior cooling mode condition, block or permit introduction of the refrigerant to the sub-evaporator, or bypass the refrigerant before being introduced to the sub-evaporator to an inlet of the compressor while allowing the refrigerant to flow along a preset path.

2. The vehicular air conditioner of claim 1, wherein the main evaporator is used for front seat side cooling in a vehicle interior,
the sub-evaporator is used for rear seat side cooling in the vehicle interior, and
the refrigerant flow control part includes a three-way flow control valve with integrated on/off function installed in the refrigerant circulation line between the condenser and the sub-evaporator to block or open a portion of the refrigerant circulation line between the condenser and the sub-evaporator or to bypass the refrigerant before being introduced to the sub-evaporator, a bypass line configured to bypass the refrigerant bypassed from the three-way flow control valve to the inlet of the compressor along a preset path, and a valve control part configured to control the three-way flow control valve according to an air conditioning mode state to block or permit refrigerant flow to the sub-evaporator or to bypass the refrigerant before being introduced to the sub-evaporator to the bypass line.

3. The vehicular air conditioner of claim 2, wherein when the rear seat side cooling mode is turned off under the vehicle interior cooling mode condition, the valve control part controls the three-way flow control valve to block the refrigerant circulation line between the condenser and the sub-evaporator and block the refrigerant flow to the sub-evaporator.

4. The vehicular air conditioner of claim 3, wherein when the rear seat side cooling mode is turned on under the vehicle interior cooling mode condition, the valve control part controls the three-way flow control valve to open the refrigerant circulation line between the condenser and the sub-evaporator and permit the refrigerant flow to the sub-evaporator.

5. The vehicular air conditioner of claim 4, wherein when a rear seat passenger wants mild wind and selects a rear seat blowing mode under the vehicle interior cooling mode condition, the valve control part controls the three-way flow control valve to bring a portion of the refrigerant circulation line on the condenser side into communication with the bypass line to bypass the refrigerant before being introduced to the sub-evaporator to the bypass line.

6. The vehicular air conditioner of claim 5, wherein the bypass line is configured so that the total refrigerant flow volume inside the bypass line is the same as the total refrigerant flow volume from the three-way flow control valve to the sub-evaporator and the compressor, and when the rear seat passenger wants the mild wind and selects the rear seat blowing mode, the bypass line can accommodate the same amount of refrigerant as the refrigerant accommodation amount in a path from the three-way flow control valve to the sub-evaporator and the compressor.

7. The vehicular air conditioner of claim 6, wherein the bypass line further includes a throttle valve configured to depressurize the bypassed refrigerant and introduce the bypassed refrigerant to the compressor.

8. The vehicular air conditioner of claim 7, further comprising:
a gas-liquid separator installed in the refrigerant circulation line between the bypass line and the inlet of the compressor to separate the refrigerant recovered to the compressor side into a gas-phase refrigerant and a liquid-phase refrigerant.

9. The vehicular air conditioner of claim 8, wherein the gas-liquid separator is installed in a portion of the refrigerant circulation line between the bypass line and the inlet of the compressor on the common downstream side of the bypass line and the main evaporator and the sub-evaporator.

10. The vehicular air conditioner of claim 6, wherein the three-way flow control valve has an expansion valve function so that the three-way flow control valve can depressurize and expand the refrigerant bypassed to the bypass line and introduce the expanded refrigerant to the compressor side.

11. The vehicular air conditioner of claim 10, further comprising:
a gas-liquid separator installed in the refrigerant circulation line between the bypass line and the inlet of the compressor to separate the refrigerant recovered to the compressor side into a gas-phase refrigerant and a liquid-phase refrigerant.

12. The vehicular air conditioner of claim 2, wherein when the rear seat side cooling mode is turned off under the vehicle interior cooling mode condition, the valve control part controls the three-way flow control valve to bring a portion of the refrigerant circulation line on the condenser side into communication with the bypass line to bypass the refrigerant before being introduced to the sub-evaporator to the bypass line.

13. The vehicular air conditioner of claim 2, wherein when the front seat side cooling mode is turned off and the rear seat side cooling mode is turned on under the vehicle interior cooling mode condition, the refrigerant flow control part controls the three-way flow control valve to bypass the refrigerant on the condenser side introduced to the main evaporator to the bypass line.

14. The vehicular air conditioner of claim 13, wherein when the front seat side cooling mode is turned off and the rear seat side cooling mode is turned on under the vehicle interior cooling mode condition, the valve control part controls the expansion valve for the main evaporator to block introduction of the refrigerant to the main evaporator side, and controls the three-way flow control valve to bring the refrigerant circulation line on the condenser side into communication with the refrigerant circulation line on the sub-evaporator side and bring the refrigerant circulation line on the condenser side into communication with the bypass line, thereby permitting the refrigerant flow to the sub-evaporator and bypassing the refrigerant introduced to the main evaporator to the bypass line.
